(19) United States
(12) Patent Application Publication
(10) Pub. No.: US 2020/0221001 A1
(43) Pub. Date: Jul. 9, 2020

(54) ELECTRONIC DEVICE AND METHOD OF SWITCHING LIGHT RECEIVING DIRECTION OF ELECTRONIC DEVICE

(71) Applicant: AU Optronics Corporation, Hsin-chu (TW)

(72) Inventors: Yen-Hua LO, HSIN-CHU (TW); Hsing-Yi HSIEH, HSIN-CHU (TW); Hsin-Chun HUANG, HSIN-CHU (TW)

(21) Appl. No.: 16/402,670

(22) Filed: May 3, 2019

(30) Foreign Application Priority Data
Jan. 7, 2019 (TW) 108100582

(51) Int. Cl. H04N 5/225; H04N 5/238; H04N 17/00

(52) U.S. Cl. CPC H04N 5/2257; H04N 17/002; H04N 5/238; H04N 5/2254

(57) ABSTRACT

An electronic device includes a main body, an image capturing component, and a light guiding element. The main body has a first surface and a second surface opposite to the first surface. The first surface has a first light inlet. The image capturing component is disposed within the main body and has a second light inlet. A projection of the second light inlet on the first surface is spaced apart from the first light inlet. The light guiding element is disposed within the main body and optically connects the first light inlet to the second light inlet.

### RELATED APPLICATIONS

This application claims priority to Taiwan Application Serial Number 108100582, filed Jan. 7, 2019, which is herein incorporated by reference.

### BACKGROUND

### Field of Invention

The present disclosure relates to an electronic device and a method of switching a light receiving direction of the electronic device.

### Description of Related Art

A handheld electronic device includes many functions, such as a display function and a photography function. In order to achieve the aforementioned functions, the electronic device includes both a display module and a photography module. The photography module occupies a portion of space of the electronic device, and a displayable range of the display module is reduced. Therefore, how to find a method for increasing the displayable range of the display module under the premise of including the photography module is one of the important topics in this field.

### SUMMARY

An aspect of the present disclosure is to provide an electronic device including a main body, an image capturing component, and a light guiding element. The main body has a first surface and a second surface opposite to the first surface. The first surface has a first light inlet. The image capturing component is disposed within the main body and has a second light inlet. A projection of the second light inlet on the first surface is spaced apart from the first light inlet. The light guiding element is disposed within the main body and optically connects the first light inlet to the second light inlet.

Another aspect of the present disclosure is to provide an electronic device including a main body, an image capturing component, and a light guiding element. The main body has a first surface and a second surface opposite to the first surface. The first surface has a first light inlet configured to receive a first light. The second surface has a second light inlet configured to receive a second light. The image capturing component is disposed within the main body. The image capturing component has a third light inlet, and a projection of the third light inlet on the first surface is spaced apart from the first light inlet. The light guiding element is disposed within the main body, in which the first light inlet, the light guiding element, and the third light inlet collectively form a first optical path. The first light enters the image capturing component via the first optical path, the second light inlet and the third light inlet collectively form a second optical path, and the second light enters the image capturing component via the second optical path.

Another aspect of the present disclosure is to provide a method of switching a light receiving direction of an electronic device. The electronic device includes an image capturing component, a first grating, and a second grating. The method of switching light receiving direction includes: selecting a first mode or a second mode; opening the first grating and closing the second grating when the first mode is selected, such that first light passes through the first grating and is received by the image capturing component; and closing the first grating and opening the second grating when the second mode is selected, such that a second light passes through the second grating and is received by the image capturing component.

In the aforementioned embodiments of the present disclosure, the first light enters the image capturing component through the first light inlet and the light guiding element to enable the image capturing component to capture an external image. Since the first light inlet is spaced apart from a light inlet of the image capturing component, the image capturing component is partially disposed under a display region of the electronic device, thereby reducing the area required for the non-display region. As a result, the electronic device in the present disclosure has the advantage of higher screen-to-body ratio.

### BRIEF DESCRIPTION OF THE DRAWINGS

The disclosure can be more fully understood by reading the following detailed description of the embodiments, with reference made to the accompanying drawings as follows:

FIG. 1A is a schematic top view of an electronic device according to an embodiment of the present disclosure;

FIG. 1B is a schematic cross-sectional view viewed along line B-B shown in FIG. 1A;

FIG. 2A is a schematic cross-sectional view of an electronic device under a turn-off mode according to another embodiment of the present disclosure;

FIG. 2B is a schematic cross-sectional view of the electronic device shown in FIG. 2A under a first mode;

FIG. 2C is a schematic cross-sectional view of the electronic device shown in FIG. 2A under a second mode;

FIG. 3A is a schematic cross-sectional view of an electronic device according to another embodiment of the present disclosure;

FIG. 3B a schematic cross-sectional view of the electronic device shown in

FIG. 3A under a first mode;

FIG. 3C is a schematic cross-sectional view of the electronic device shown in FIG. 3A under a second mode; and

FIG. 4 is a flow chart showing a method of switching a light receiving direction of an electronic device according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

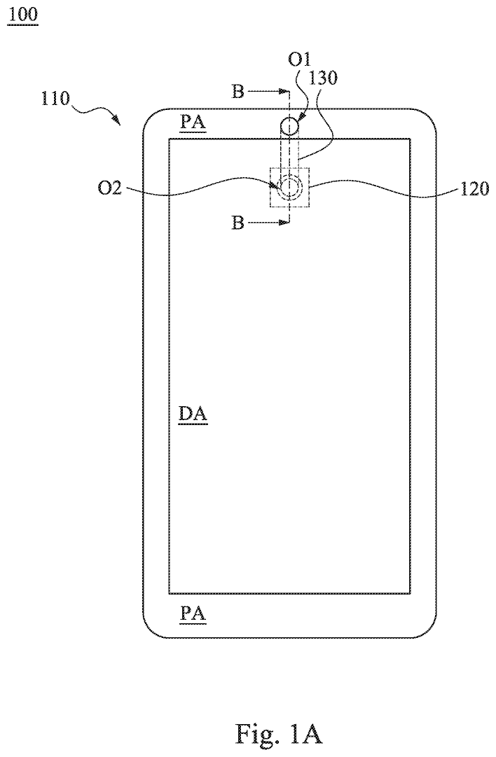

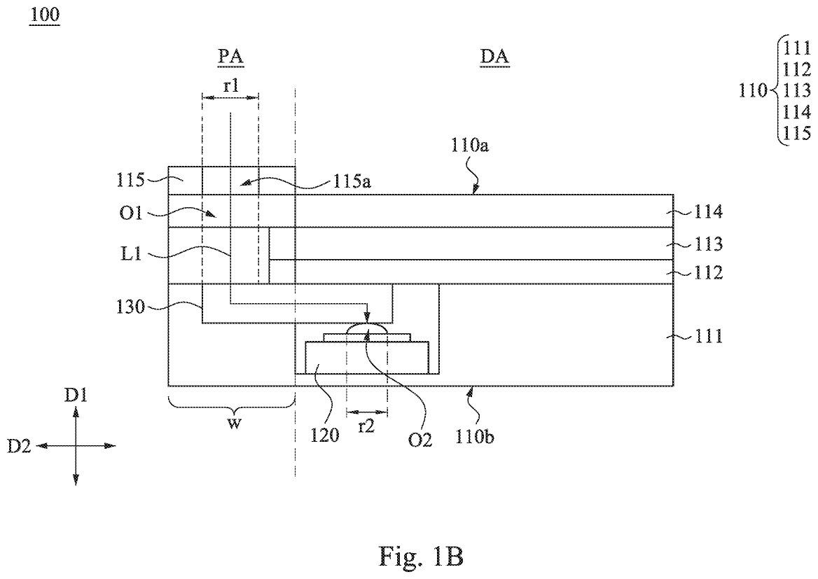

FIG. 1A is a schematic top view of an electronic device 100 according to an embodiment of the present disclosure. As shown in FIG. 1A, the electronic device 100 includes a main body 110, an image capturing component 120, and a light guiding element 130. The image capturing component 120 and the light guiding element 130 are disposed within the body 110, and thus are shown by dotted lines in FIG. 1A.

FIG. 1B is a schematic cross-sectional view viewed along line B-B shown in FIG. 1A. As shown in FIG. 1B, the main body 110 has a first surface 110a and a second surface 110b. The first surface 110a and the second surface 110b are opposite to each other, and a first light inlet O1 is on the first surface 110a. The image capturing component 120 has a second light inlet O2. As shown in FIG. 1A, a projection of the second light inlet O2 on the first surface 110a is spaced apart from the first light inlet O1. The light guiding element 130 optically connects the first light inlet O1 to the second light inlet O2.

As shown in FIG. 1A and FIG. 1B, in the present embodiment, the electronic device 100 is a mobile phone having a photography function. In other embodiments, the electronic device 100 may also be another device having a photography function and a display function. The electronic device 100 can display an image from the first surface 110a.

As shown in FIG. 1B, the main body 110 of the electronic device 100 includes a base 111, a backlight module 112, a display module 113, a cover 114, and a front frame 115. The base 111 forms the second surface 110b of the main body 110 and is configured to support the backlight module 112 to be located on the base 111. The backlight module 112, the display module 113, and the cover 114 are sequentially disposed on the base 111. The cover 114 forms the first surface 110a of the main body 110, and the front frame 115 is disposed on the cover 114 and located at an edge of the electronic device 100.

In the present embodiment, the electronic device 100 can display a color image by adopting a liquid crystal display principle. As shown in FIG. 1B, when the electronic device 100 is under operation, the backlight module 112 emits light toward the display module 113, and the light passes through a liquid crystal layer and a color filter layer in the display module 113 and then passes through the transparent cover 114. An image is displayed on the first surface 110a of the electronic device 100. That is, the display module 113 displays an image toward the first surface 110a. In the present embodiment, the image capturing component 120 is disposed on a side of the display module 113 facing away from the first surface 110a.

It should be understood that, in other embodiments, the electronic device 100 can display an image by adopting different display principles. For example, the backlight module 112 and the display module 113 can be modified into an organic light emitting diode (OLED) display module in some embodiments.

As shown in FIG. 1A and FIG. 1B, the cover 114 of the electronic device 100 is further covered by the front frame 115. The region of the first surface 110a covered by the front frame 115 is referred to as a frame region PA, and the region the first surface 110a that is not covered by the front frame 115 is referred to as a display region DA. The front frame 115 may be made of an opaque material to cover various functional components located below the frame region PA. For example, the functional component may be an element having a photography function, an infrared ray sensing element, a radio element, an acoustic element, a light emitting element, or the like.

In the present embodiment, the first light entrance O1 is defined by a projection of an opening 115a of the front frame 115 on the first surface 110a. For example, since the cover 114 is made of a transparent material, the first light inlet O1 may be formed from a non-hole structure. However, in some embodiments, the first light inlet O1 of the cover 114 may be a hole structure, but the present disclosure is not limited in this regard.

In particular, a size of the frame region PA is related to a critical dimension of the functional components mounted therein. The critical dimension refers to the dimension of the largest functional component of all of the functional components, and thus a width w of the frame region PA should be greater than the critical dimension. For example, in the present embodiment, the size of the first light inlet O1 may be the aforementioned critical dimension. As shown in FIG. 1B, in the case of the first light inlet O1 having a first aperture r1, the width w of the frame region PA also needs to be greater than the size (diameter) of the first aperture r1.

As shown in FIG. 1A and FIG. 1B, in the present embodiment, the image capturing component 120 is disposed on the base 111 and located between the base 111 and the display module 113. In other words, a projection of the image capturing component 120 on the first surface 110a is at least partially located within the display region DA of the first surface 110a. In the present embodiment, the projection of the image capturing component 120 on the first surface 110a is entirely located in the display area DA, such that the projection of the second light inlet O2 of the image capturing component 120 on the first surface 110a is completely separated from the first light inlet O1.

In other embodiments, the projection of the image capturing component 120 on the first surface 110a may be partially located in the display region DA and partially located in the frame region PA. In this case, the first light inlet O1 and the projection of the second light inlet O2 on the first surface 110a may partially overlap with each other.

As shown in FIG. 1A and FIG. 1B, the light guiding element 130 is located between the first light inlet O1 and the second light inlet O2, and the projection of the light guiding element 130 on the first surface 110a is connected to the projection of the second light inlet O2 on the first surface 110a. The light guiding element 130 is configured to change the direction of the light. In the present embodiment, the light guiding element 130 extends in a second direction D2.

With the above configuration, first light L1 may enter the main body 110 in the first direction D1 via the first light inlet O1, and then is guided in the second direction D2 through the light guiding element 130, and thereafter is guided to the second light inlet O2 through the light guiding element 130 and is received by the image capturing component 120. Specifically, the light guiding element 130 may be selected from a group consisting of an optical fiber, a double reflecting mirror, a graded index layer, and a Bragg reflecting grating.

As shown in FIG. 1B, in the present embodiment, the second light inlet O2 of the image capturing component 120 faces toward the first surface 110a, but the present disclosure is not limited in this regard. For example, the second light inlet O2 of the image capturing component 120 may face toward the second surface 110b as long as the light guiding element 130 can guide the first light L1 into the second light inlet O2.

As shown in FIG. 1B, in the present embodiment, the second light inlet O2 has a second aperture r2 representing the aperture size of the image capturing component 120. The first aperture r1 of the first light inlet O1 may be greater than or equal to the second aperture r2 to ensure sufficient amount of light input.

In summary, the first light L1 can enter the image capturing component 120 through the first light inlet O1, the light guiding element 130, and the second light inlet O2 sequentially, such that the image capturing component 120 captures the external image. Since the image capturing component 120 is partially disposed under the display region DA, the width w of the front frame 115 only needs to be greater than the size (diameter) of the second aperture r2 of the second light inlet O2 of the image capturing component 120, and can be smaller than the size of the image capturing component 120 itself. As a result, the front frame 115 of the electronic device 100 of the present disclosure has the smaller width w and has the advantage of higher screen-to-body ratio.

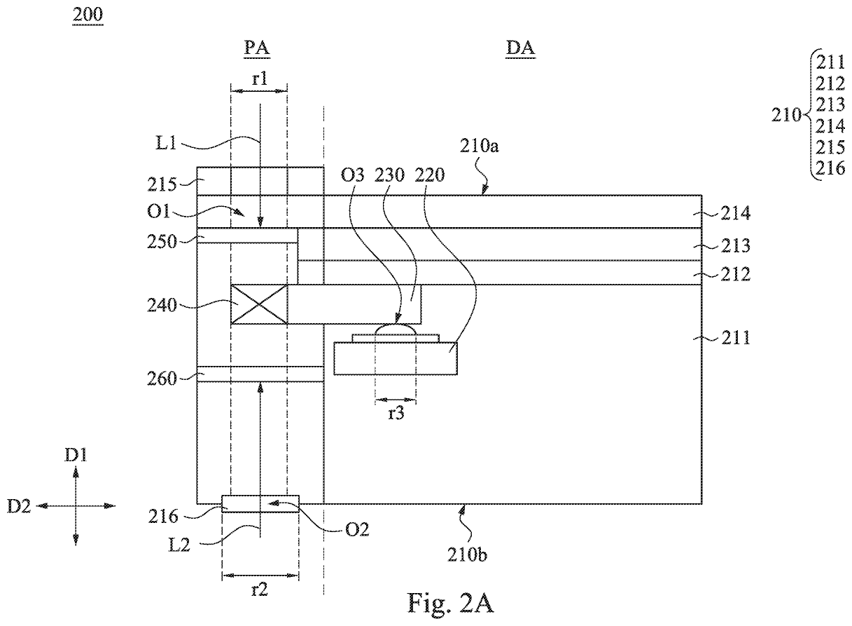

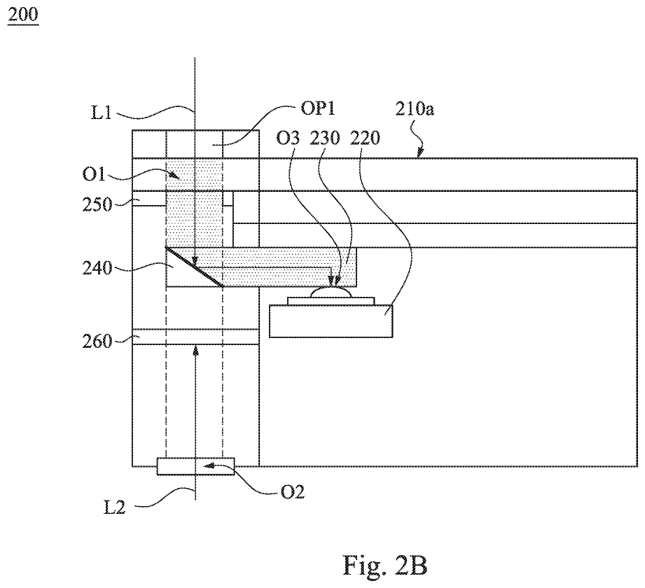

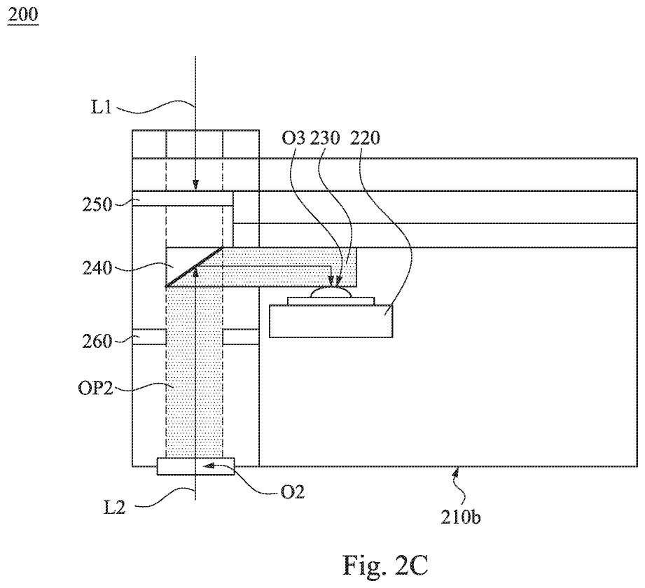

FIG. 2A is a schematic cross-sectional view of an electronic device 200 under a turn-off mode according to another embodiment of the present disclosure. As shown in FIG. 2A, the electronic device 200 includes a main body 210, an image capturing component 220, a light guiding element 230, a light coupling element 240, a first grating 250, and a second grating 260. The main difference between the electronic device 200 shown in FIG. 2A and the electronic device 100 shown in FIG. 1B is that the electronic device 200 has a mode-switching function that allows the image capturing component 220 to receive light from different directions.

As shown in FIG. 2A, the main body 210 includes a base 211, a backlight module 212, a display module 213, a cover 214, a front frame 215, and a back cover 216, which are similar to those shown in FIG. 1A. The main difference is that the second surface 210b of the base 211 further has a second light inlet O2, and the back cover 216 is further disposed at a position of the second light inlet O2. In particular, the back cover 216 may be formed from a transparent material such as acryl, glass, or the like.

As shown in FIG. 2A, the first light inlet O1 is configured to receive first light L1, and the second light inlet O2 is configured to receive second light L2. The image capturing component 220 has a third light inlet O3 configured to receive the first light L1 under the first mode and the second light L2 under the second mode.

In the present embodiment, a projection of the third light inlet O3 on the first surface 210a is spaced apart from the first light inlet O1, and the projection of the second light inlet O2 on the first surface 210a overlaps with the first light inlet O1. However, in some embodiments, the first light inlet O1 and the second light inlet O2 may be partially or completely separated from each other, but the present disclosure is not limited to those shown in FIG. 2A.

As shown in FIG. 2A, the light coupling element 240 is connected to the light guiding element 230, and the light coupling element 240 is disposed between the first light inlet O1 and the second light inlet O2. The light coupling element 240 is configured to couple the first light L1 with the second light L2. The so-called coupling of the first light L1 with the second light L2 is to integrate the first light L1 and the second light L2 traveling in different directions into light traveling in the same direction. For example, in the present embodiment, the first light L1 travels in the second direction D2 after passing through the light coupling element 240, and the second light L2 also travels in the second direction D2 after passing through the light coupling element 240. Specifically, the light coupling component 240 may be selected from a group consisting of a beam splitter, a two-to-one fiber, and a curved mirror.

As shown in FIG. 2A, the first light L1 or the second light L2 traveling in the second direction D2 after passing through the light coupling element 240 will enter the light guiding element 230 and is guided by the light guiding element 230 into the third light inlet O3 of the image capturing component 220, and then is received by the image capturing component 220.

In the present embodiment, the projection of the light guiding element 230 on the first surface 210a connects the projection of the first light inlet O1 to the third light inlet O3 on the first surface 210a, and the projection of the light guiding element 230 on the second surface 210b covers the second light inlet O2 and the projection of the third light inlet O3 on the second surface 210b. Other descriptions regarding the light guiding element 230 can be referred to the foregoing description of the light guiding element 130, and will not be described again herein.

As shown in FIG. 2A, the first grating 250 is disposed between the light coupling element 240 and the first light inlet O1, and is electrically connected to the controller. The first grating 250 can be opened or closed according to the signal of the controller. Specifically, when the first grating 250 is opened, the first light L1 entering via the first light inlet O1 can be allowed to enter the light coupling element 240; and when the first grating 250 is closed, the first light L1 will be blocked by the first grating 250 and cannot enter the light coupling element 240.

Similarly, the second grating 260 is disposed between the light coupling element 240 and the second light inlet O2, and is electrically connected to the controller. The second grating 260 can be opened or closed according to the signal of the controller. Specifically, when the second grating 260 is opened, the second light L2 entering via the second light inlet O2 can be allowed to enter the light coupling element 240; and when the second grating 260 is closed, the second light L2 will be blocked by the second grating 260 and cannot enter the light coupling element 240.

That is to say, the electronic device 200 can selectively allow the first light L1 or the second light L2 to enter the main body 210 by using the design of the first grating 250 and the second grating 260. In the case shown in FIG. 2A, both the first grating 250 and the second grating 260 are closed, that is, neither the first light L1 nor the second light L2 can enter the body 210, when the electronic device 200 is under the turn-off mode. When the first grating 250 is opened and the second grating 260 is closed, it means that the electronic device 200 is under a first mode (as shown in FIG. 2B); and when the first grating 250 is closed and the second grating 260 is opened, means that the electronic device 200 is under a second mode (as shown in FIG. 2C). For example, the first grating 250 and the second grating 260 may be lens grating of a general camera, or other mechanisms that can block the light path.

FIG. 2B is a schematic cross-sectional view of the electronic device 200 shown in FIG. 2A under a first mode. As shown in FIG. 2B, under the first mode, since the first grating 250 is opened, the first light inlet O1, the light coupling element 240, the light guiding element 230, and the third light inlet O3 can form the first light path OP1 (illustrated by a dotted area in the drawings). The first light L1 can enter the image capturing component 220 along the first light path OP1. That is to say, in the first mode, the image capturing component 220 can capture image information from one side of the first surface 210a of the electronic device 200.

FIG. 2C is a schematic cross-sectional view of the electronic device 200 shown in FIG. 2A under a second mode. Similarly, under the second mode, since the second grating 260 is open, the second light inlet O2, the light coupling element 240, the light guiding element 230, and the third light inlet O3 can form a second optical path OP2 (illustrated by a dotted area in the drawings). The second light L2 can enter the image capturing component 220 along the second optical path OP2. That is to say, under the second mode, the image capturing component 220 can capture image information from one side of the second surface 210b of the electronic device 200.

As shown in FIG. 2A, the first light inlet O1 has a first aperture r1, the second light inlet O2 has a second light entrance O2, and the third light inlet O3 has a third aperture r3. In the present embodiment, the sizes of the first aperture r1 and the second aperture r2 may be greater than or equal to the size of the third aperture r3 to ensure that sufficient amount of light input. The size of the first aperture r1 may be greater than, equal to, or smaller than the size of the second aperture r2.

As shown in FIG. 2A, the first light inlet O1 and the second light inlet O2 are both located within the range of the frame region PA. The projection of the third optical inlet O3 on the first surface 210a is completely separated from the first optical inlet O1, and the projection of the third optical inlet O3 on the second surface 210b is completely separated from the second optical inlet O2, such that the image capturing component 220 is disposed below the display region DA. That is to say, the electronic device 200 in the present embodiment also has the advantages of the electronic device 100. In particular, since the width w of the frame region PA only needs to be greater than the size of the third aperture r3 of the third light inlet O3 of the image capturing component 220, the electronic device 200 also has the advantage of higher screen-to-body ratio.

In addition, the electronic device 200 can be switched between the off mode, the first mode, and the second mode by the opening and closing of the first grating 250 and the second grating 260, in which the first mode and the second mode can capture images from different sides of the electronic device 200. On the other hand, the electronic device 200 only needs to configure one image capturing component 220 for receiving image information from different directions, thereby effectively reducing cost and saving space.

It should be understood that the electronic device 200 shown in FIG. 2A to FIG. 2C is merely illustrated as an example, and various changes can be made by those skilled in the art according to practical needs. For example, the light coupling element 240 only needs to be disposed at an overlapping position between the first optical path OP1 and the second optical path OP2. On the other hand, the first grating 250 can be disposed at any position on the first optical path OP1, and is not necessarily to be disposed between the light coupling element 240 and the first light inlet O1. Similarly, the second grating 260 can be disposed at any position on the second optical path OP2, and is not necessarily to be disposed between the light coupling element 240 and the second light inlet O2.

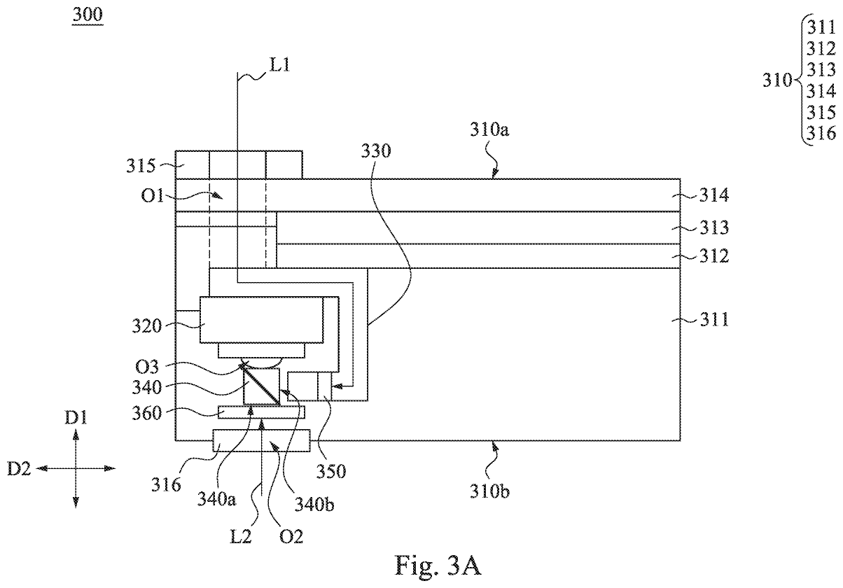

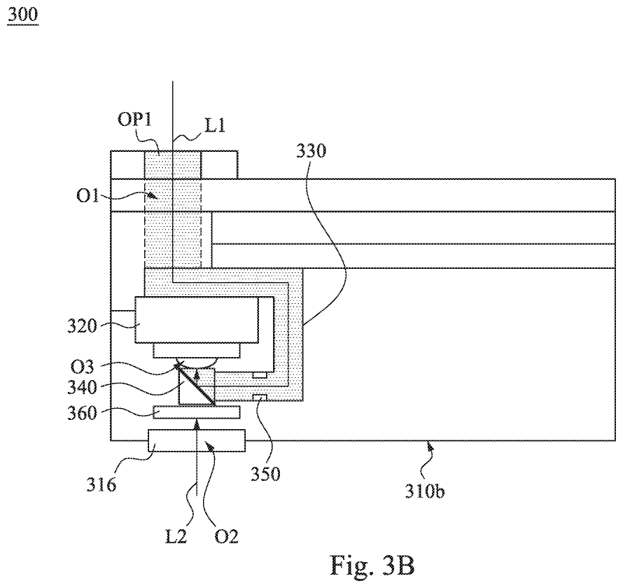

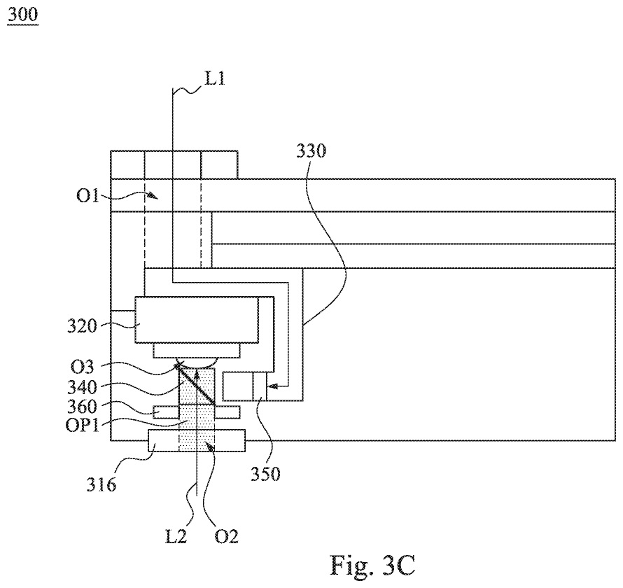

For example, FIG. 3A is a schematic cross-sectional view of an electronic device 300 according to another embodiment of the present disclosure. As shown in FIG. 3A, the electronic device 300 includes a main body 310, an image capturing component 320, a light guiding element 330, a light coupling element 340, a first grating 350, and a second grating 360.

As shown in FIG. 3A, the main body 310 includes a base 311, a backlight module 312, a display module 313, a cover 314, a front frame 115, and a back cover 316. Most of the elements shown in FIG. 3A are similar to the elements shown in FIG. 2A, and will not be described again herein.

As shown in FIG. 3A, the main body 310 has a first surface 310a and a second surface 310b opposite to the first surface 310a, and the first surface 310a has a first light inlet O1, and the second surface 310b has a second light inlet O2. The first light inlet O1 is configured to receive the first light L1, and the second light inlet O2 is configured to receive the second light L2. The image capturing component 320 has a third light inlet O3 configured to receive the first light L1 under the first mode and the second light L2 under the second mode.

In the present embodiment, the projection of the third light inlet O3 on the first surface 210a is separated from the first light inlet O1, and the projection of the third light inlet O3 on the second surface 210b overlaps with the second light inlet O2. On the other hand, the projection of the second light inlet O2 on the first surface 210a is spaced apart from the first light inlet O1.

As shown in FIG. 3A, the light coupling element 340 is disposed between the image capturing component 320 and the second light inlet O2, and is configured to couple the first light L1 with the second light L2. In the present embodiment, the first light L1 is guided by the light guiding element 330, and travels in the second direction D2 before entering the light coupling elements 340. After the first light L1 enters the light coupling element 340, its traveling direction changes into the first direction D1. The second light L2 travels in the first direction D1 after entering the second light inlet O2, and does not change the traveling direction after entering the light coupling element 340 and continues to travel in the first direction D1.

In other words, the first light L1 and the second light L2 can enter the third light inlet O3 of the image capturing component 320 through the light coupling element 340 and/or the light guiding element 330, thereby allowing the image capturing component 320 to receive light from different sides of the electronic device 300.

As shown in FIG. 3A, the electronic device 300 can perform mode-switching by using the first grating 350 and the second grating 360. Specifically, the first grating 350 and the second grating 360 are respectively disposed on two sides of the light coupling element 340. In the present embodiment, the second grating 360 of the electronic device 300 is disposed on the first side 340a of the light coupling element 340 facing toward the second surface 310b, and the first grating 350 is disposed on the second side 340b adjacent to the first side 340a.

The first grating 350 and the second grating 360 are electrically connected to the controller, and can be opened or closed according to the signal of the controller. As shown in FIG. 3A, when the first shutter 350 is closed, the first light L1 is blocked by the first grating 350 from entering the light coupling element 340; and when the second grating 360 is closed, the second light L2 is blocked by the second grating 360 from entering the optical coupling element 340.

In the case shown in FIG. 3A, the first grating 350 and the second grating 360 are both closed, that is, neither the first light L1 nor the second light L2 can be received by the image capturing component 320, when the electronic device 300 is under the turn-off mode. When the first grating 350 is opened and the second grating 360 is closed, it means that the electronic device 300 is under a first mode (as shown in FIG. 3B); and when the first grating 350 is closed and the second shutter 360 is opened, it means that the electronic device 300 is under a second mode (as shown in FIG. 3C).

FIG. 3B a schematic cross-sectional view of the electronic device 300 shown in FIG. 3A under the first mode. As shown in FIG. 3B, the third light inlet O3 of the image capturing component 320 faces toward the second surface 310b, and the light guiding element 330 is optically connected to the third light inlet O3 by the first light inlet O1. As a result, when the first grating 350 is opened, the first light L1 can be received by the image capturing component 320 through the light guiding element 330 and the light coupling element 340, such that the image on one side of the first surface 310a is captured by image capturing component 320.

FIG. 3C is a schematic cross-sectional view of the electronic device shown 300 in FIG. 3A under the second mode. As shown in FIG. 3C, the second light inlet O2 and the third light inlet O3 are aligned. Therefore, when the second grating 360 is opened, the second light L2 can directly pass through the light coupling element 340 and enters the image capturing component 320 without the light guiding element 330 being disposed between the light coupling element 340 and the second light inlet O2.

In summary, the electronic device 300 also has the advantages of the electronic device 100 or the electronic device 200. For example, the electronic device 300 has a higher screen-to-body ratio and a mode switching function.

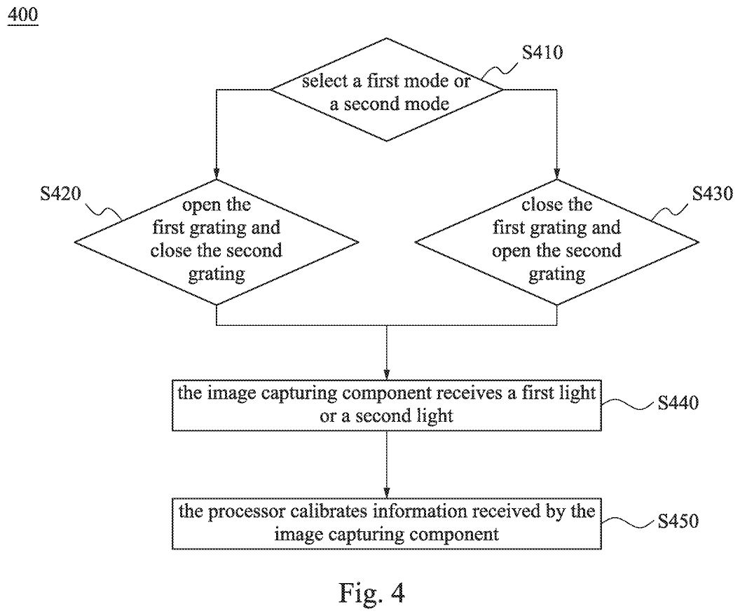

FIG. 4 is a flow chart showing a method 400 of switching a light receiving direction of an electronic device 300 according to an embodiment of the present disclosure. It should be understood that the electronic device 300 is used herein as an example for explanation, and the method 400 can also be applicable to the electronic device 200. As shown in FIG. 4, the method 400 begins with step S410 for selecting the first mode or the second mode.

As shown in FIG. 3A and FIG. 4, if the first mode is selected in step S410, step S420 is performed for opening the first grating 350 and closing the second grating, such that the first light L1 passes through the first grating 350. If the second mode is selected in step S410, step S430 is performed for closing the first grating 350 and opening the second grating 360, such that the second light L2 passes through the second grating 360.

After step S410 or S420, the image capturing component 320 receives the first light L1 or the second light L2, and transmits the image information to the processor (step 430).

Then, step S440 is performed for using the processor to calibrate the information received by the image capturing component 320. For example, as shown in FIG. 3A, since the first light L1 passes through the light guiding element 330 and the light coupling element 340, a first error may occur, and the first error may be corrected by the first algorithm. In contrast, the second L2 only passes through the light coupling element 340, such that a second error may occur, and the second error can be corrected by the second algorithm. It should be understood that the first algorithm and the second algorithm may be the same or different, of which those skilled in the art can design according to practical needs.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. An electronic device, comprising:
a main body having a first surface and a second surface opposite to the first surface, wherein the first surface has a first light inlet;
an image capturing component disposed within the main body, wherein the image capturing component has a second light inlet, and a projection of the second light inlet on the first surface is spaced apart from the first light inlet; and
a light guiding element disposed within the main body, wherein the light guiding element optically connects the first light inlet to the second light inlet.

2. The electronic device of claim 1, wherein the projection of the second light inlet on the first surface is completely separated from the first light inlet.

3. The electronic device of claim 1, wherein a projection of the light guiding element on the first surface covers the first light inlet and the projection of the second light inlet on the first surface.

4. The electronic device of claim 1, wherein the first surface of the main body has a display region and a frame region, the first light inlet is located at the frame region, and a projection of the image capturing component on the first surface is at least partially located at the display region.

5. The electronic device of claim 1, wherein the main body comprises a display module, the display module displays an image toward the first surface, and the image capturing component is at least partially located on a side of the display module facing away from the first surface.

6. The electronic device of claim 1, wherein the light guiding element is selected from a group consisting of an optical fiber, a double reflecting mirror, a graded index layer, and a Bragg reflecting grating.

7. The electronic device of claim 1, wherein the second light inlet of the image capturing component faces toward the first surface.

8. The electronic device of claim 1, wherein a size of the first light inlet is larger than or equal to a size of the second light inlet.

9. An electronic device, comprising:
a main body having a first surface and a second surface opposite to the first surface, wherein the first surface has a first light inlet to receive first light, and the second surface has a second light inlet to receive second light;
an image capturing component disposed within the main body, wherein the image capturing component has a third light inlet, and a projection of the third light inlet on the first surface is spaced apart from the first light inlet; and
a light guiding element disposed within the main body, wherein the first light inlet, the light guiding element, and the third light inlet collectively form a first optical path, the first light enters the image capturing component via the first optical path, the second light inlet and the third light inlet collectively form a second optical path, and the second light enters the image capturing component via the second optical path.

10. The electronic device of claim 9, further comprising:
a light coupling element that is disposed at an overlapped portion between the first optical path and the second optical path and is configured to couple the first light with the second light.

11. The electronic device of claim 10, wherein the light coupling element is selected from a group consisting of a beam splitter, a two-to-one fiber, and a curved mirror.

12. The electronic device of claim 9, wherein a projection of the light guiding element on the first surface covers the first light inlet and a projection of the third light inlet on the first surface, and a projection of the light guiding element on the second surface covers the second light inlet and a projection of the third light inlet on the second surface.

13. The electronic device of claim 9, wherein the first surface of the main body has a display region and a frame region, the first light inlet is located in the frame region, and a projection of the image capturing component on the first surface is at least partially located in the display region.

14. The electronic device of claim 9, wherein the main body comprises a display module, the display module displays an image toward the first surface, and the light guiding element is at least partially located on a side of the display module facing away from the first surface.

15. The electronic device of claim 9, wherein a size of the first light inlet is larger or equal to a size of the third light inlet, and a size of the second light inlet is larger or equal to the size of the third light inlet.

16. The electronic device of claim 9, further comprising:
a first grating disposed on the first optical path; and
a second grating disposed on the second optical path.

17. The electronic device of claim 9, wherein a projection of the third light inlet on the second surface is spaced apart from the second light inlet.

18. The electronic device of claim 9, wherein a projection of the third light inlet on the second surface overlaps the second light inlet.

19. The electronic device of claim 18, wherein the third light inlet of the image capturing component faces toward the second surface.

20. A method of switching a light receiving direction of an electronic device, wherein the electronic device comprises an image capturing component, a first grating, and a second grating, and the method of switching light receiving direction comprises:
selecting a first mode or a second mode;
opening the first grating and closing the second grating when the first mode is selected, such that first light passes through the first grating and is received by the image capturing component; and
closing the first grating and opening the second grating when the second mode is selected, such that second light passes through the second grating and is received by the image capturing component.

21. The method of switching the light receiving direction of the electronic device of claim 20, wherein the first light is incident on a first surface of the electronic device, the second light is incident on a second surface of the electronic device, and the first surface and the second surface is opposite to each other.

22. The method of switching the light receiving direction of the electronic device of claim 20, further comprising:
calibrating information received by the image capture device by using a processor, wherein the processor performs a first algorithm when the first mode is selected and executes a second algorithm when the second mode is selected, and the first algorithm is different from the second algorithm.
